(19) United States
(12) Patent Application Publication
(10) Pub. No.: US 2018/0014528 A1
(43) Pub. Date: Jan. 18, 2018

(54) DISPENSING DEVICE FOR ANIMAL ATTRACTANT

(71) Applicants: Jonathan Kalasinski, South Abington Twp, PA (US); Michael Aschettino, Clinton, MA (US)

(72) Inventors: Jonathan Kalasinski, South Abington Twp, PA (US); Michael Aschettino, Clinton, MA (US)

(21) Appl. No.: 15/207,642

(22) Filed: Jul. 12, 2016

(51) Int. Cl. A01M 31/00

(52) U.S. Cl. CPC A01M 31/008

(57) ABSTRACT

The present invention relates to a device that dispenses animal attractant and lure scents particularly a heated scent dispenser that includes: a scent container; a heater and wick assembly that extends up when in use exposing the wicks and down into the scent container when not in use; a cap on top of the heater and wick assembly that spins freely to not twist the wires of the heater, where the cap includes a means to mount the dispenser device; a power switch, where the power switch is adapted to enable a user to activate or deactivate the heater; and a power source. The means to mount may include a hook, where the hook is adapted to allow a user to hang the dispenser device from a stationary object or the flat base that allows the device to be placed on a surface.

### BACKGROUND OF THE INVENTION

### Field of Invention

The present invention relates to a device that dispenses animal attractant and lure scents particularly a heated scent dispenser.

### Background of Invention

Smell is the ability of an organism to perceive scents or odors in an environment. Scents are made up of aromatic molecules and the level of kinetic energy within the scent molecule determines how far and fast they will travel. When a scent is heated, the aromatic molecules obtain more kinetic energy allowing them to travel faster and farther. When a scent is cooled, it will travel less and when the temperature of the scent reaches 32° Fahrenheit (0° Celsius) or less, the scent freezes and becomes useless.

Hunters, trappers or observers often use natural or artificial scents that are commonly in a liquid or gel form. These scents are used to attract prey or an animal into their vicinity to be harvested or observed. Typical attractant scents include pheromones, urine or estrous. Animals often determine the age of a scent or marking by its temperature. If the temperature of the scent is less than 90° Fahrenheit (32° Celsius), an animal may interpret the scent or marking as old, aged, or not fresh because it is less than the temperature of a living animal. This in turn may deter the interest of the animal. The optimum method to disperse animal attractant scent is to maintain the scent at an elevated temperature above ambient temperature with the intent to diffuse the scent while avoiding instant vaporization.

One approach to dispense the scent is to pour or spray it onto the ground or objects such as branches, leaves or bushes to attract the animal within the vicinity of the intended user. Another approach is to pour the scent onto a wick and to hang the wick in the vicinity of the intended user to attract the animal or prey. The above approaches are not using the scent in the optimum manner as the scent will be at ambient temperature.

As one alternative, the liquid or gel scent may be placed on two wicks that are encapsulating an engineered waterproof heater. The heater evenly distributes the heat raising the temperature of the scent molecules to provide a more effective disbursement and promoting diffusion. The temperature of the heater is controlled to avoid instant vaporization of the scent. The power usage and desired temperature with gradual heat are controlled by the technology within the internal heater, the size of the wires and an inline resistor. This device further improves on the optimum heated scent method by allowing the wicks and the heater to be raised out of the container of scent when in use to aid in scent dispersion. The device allows the scent wicks to be lowered and stored within the scent container with ease when the device is not in use. The technology and design improves upon current methods as other devices instantly vaporize the liquid, which results in poor dispersion or rather attempt to heat all the stored liquid which does not allow optimum use of the battery supply to heat the scent.

As a result, the present invention diffuses the scent at what is considered optimum usage of scent dispersion. By heating the liquid or gel scent and promoting diffusion: the scent molecules will travel faster and farther than the current state of the substance, make the scent appear to be fresh to the prey or animal, stop the scent from freezing, and the controlled temperature will not result in instant vaporization which destroys the scent molecules.

### SUMMARY OF THE INVENTION

The present invention relates to a device that dispenses animal attractant and lure scents, particularly a heated scent dispenser, where the device includes a lower compartment, which holds a power source preferably in the form of a battery. The upper section of the device includes a scent container, where the lower compartment of the scent container holds electronic components for control purposes. The electronic components include a switch to turn the power on and off, and a LED indicating whether the device is on or off and the current remaining power within the battery, and a resistor to regulate current to the LED.

The upper compartment of the scent container includes a capsule that can store one fluid ounce of scent, a heater and wick assembly, and the heater wires. The heater wires originate in the lower electronic compartment, and pass through into the upper compartment of the scent container. The heater and wick assembly holds the two wicks against the heater. The assembly travels up in tracks within the scent container to expose the wicks when in use, and down into the scent container to store the wicks when not in use. The upper section of heater and wick assembly is inserted into the cap and held in place by a threaded stopper. The intent is to allow the heater assembly to act as a bearing inside of the cap so the cap spins freely on the assembly. The cap must spin freely to avoid damage to the heater wires. The heater and wick assembly can be pinched at the lower section and turned at an angle so it can be removed from the scent container tracks. This action allows the user to clean or replace the wicks. A hook is attached to the cap that is uniquely designed to fit multiple three branches as well as other stationary objects available in a hunting environment.

The heater's heating element is within a silicone casing that is waterproof. The heating element is arranged in a particular pattern to distribute heat evenly across the heater when energized. The heater is designed to achieve a particular delta with a gradual temperature increase to promote diffusion with the particular battery source for this intended device while avoiding instant vaporization. The heater and circuit were engineered to operate in a predetermined range with the LED illuminating only in the desired range and not simply powering off due to zero energy remaining within the battery.

### BRIEF DESCRIPTION OF DRAWINGS

FIG. 1 depicts a perspective view of a dispenser device in accordance with the present invention.

FIG. 2 depicts a sectional view of the dispensing device according to the present invention.

FIG. 3 depicts a two-dimensional front view of the dispensing device according to the present invention.

### DETAILED DESCRIPTION

The present invention relates to a device that dispenses animal attractant and lure scents, particularly a heated scent dispenser, which heats the scent during disbursement. As stated, the present invention includes a battery source that is used to supply energy to electronic components that then supply the power to a silicone waterproof heater that is within an assembly that holds wicks on both sides of the heater. The heater and wick assembly travels within tracks within the scent container. The assembly is raised during use and lowered into the scent compartment for storage when not in use. A hook is provided on the top of a cap that attaches to the heater and wick assembly. The upper section of the heater and wick assembly acts as a bearing within the cap. This allows the cap to spin freely to not twist the heater wires that extends into the scent container. Advantageously the device heats the scent on the wicks to create a realistic experience to attract animals while promoting diffusion.

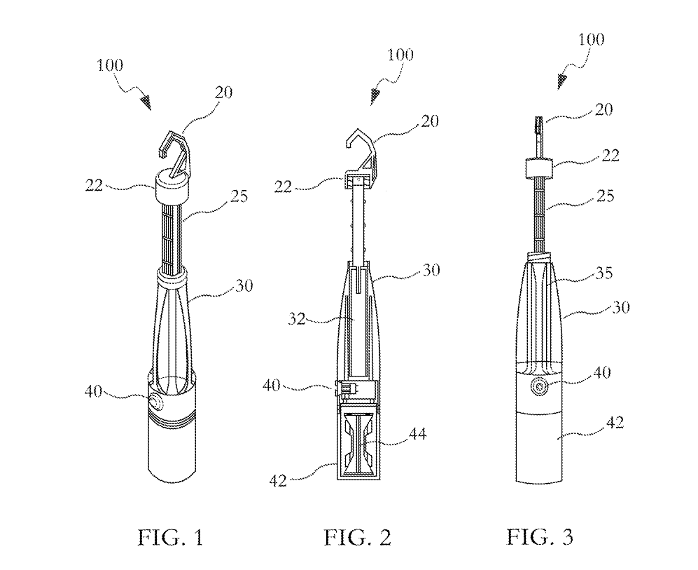

In reference to FIG. 1, a prospective view of a dispenser device according to present invention is shown. As shown in FIG. 1, dispenser device 100 includes a scent container 30 with a heater and wick assembly 25 that rises while in use and lowers to be stored into the scent container when not in use 30. A cap 22 is assembled on top of the heater and wick assembly that acts as a bearing 25 that includes a hook 20. The hook 20 allows a user to hang the dispenser device from a tree or other stationary objects. An on and off switch 40 is also shown. The switch 40 preferably includes a LED light that provides operational information regarding the use of the dispenser device 100.

A sectional view of the dispenser device 100 is shown as FIG. 2. Within the scent container 30 is a capsule 32 that receives and holds the scent material. The heater and wick assembly 25 extends into the scent capsule 32 to absorb scent material via the wicks and then heat the scent during operation when raised. Below the scent container 30 is a battery compartment 42 which holds batteries 44 that supply power to the electronic components and the switch 40 to the heater within the heater and wick assembly 25.

FIG. 3 provides a front view of the dispenser device 100 showing switch 40 above the battery compartment 42. Preferably DC batteries are used within the device. Further shown in FIG. 3 is a venting portion 35 that allows the emission of the scent from the exposed heater and wick assembly from the scent container 30. During use a user mounts the scent device 100 onto a stationary object such as a tree using the hook on the cap 20 or it can be placed on a flat surface. The electronics within the device are programmed to heat the scent at a predetermined delta explained above promoting diffusion. Therefore, the device provides properly heated scent regardless of the ambient temperatures surrounding the device within reason. The instant invention has been shown and described in what it considers to be the most practical and preferred embodiments. It is recognized, however, that departures may be made there from within the scope of the invention and that obvious modifications will occur to a person skilled in the art.

What is claimed is:

1. A dispenser device for dispensing animal attractant comprising:
a. a scent container;
b. a heater and wick assembly, wherein the heater and wick assembly is adapted to raise out of the scent container to aid in dispersion and lowered to store when not in use;
c. a cap, wherein the cap is assembled on top of the heater and wick assembly and the cap is adapted to spin independent of the heater and wick assembly, where the heater and wick assembly includes a means to mount the dispenser device;
d. a power switch, where the power switch is adapted to enable a user to activate or deactivate the dispenser device; and
e. a power source.

2. The dispenser device according to claim 1, where the means to mount includes a hook, where the hook is adapted to allow a user to hang the dispenser device from a stationary object.

3. The dispenser device according to claim 1, where the power switch includes a LED light that provides operational information regarding the use of the dispenser device.

4. The dispenser device according to claim 1, where the scent container includes a capsule adapted to receive and hold scent material.

5. The dispenser device according to claim 1, where the dispenser device includes a battery compartment below the scent container, where batteries supply power to the heater and other components of the dispenser device.

6. The dispenser device according to claim 5, where DC battery is used within the battery compartment.

7. The dispenser device according to claim 1, further including a venting portion, where the venting portion allows emission of scent from the scent container.

8. The dispenser device according to claim 1, where the heater heats the scent to a predetermined delta above the ambient temperature.
